(19) United States
(12) Patent Application Publication
(10) Pub. No.: US 2026/0046170 A1
(43) Pub. Date: Feb. 12, 2026

(54) RADIO FREQUENCY REFLECTION ARRAYS HAVING AT LEAST ONE ANTENNA ELEMENT

(71) Applicant: QUALCOMM Incorporated, San Diego, CA (US)

(72) Inventors: Danlu ZHANG, San Diego, CA (US); Yu ZHANG, San Diego, CA (US); Peter GAAL, San Diego, CA (US); Tingfang JI, San Diego, CA (US)

(21) Appl. No.: 19/100,324

(22) PCT Filed: Sep. 23, 2022
(86) PCT No.: PCT/CN2022/120698

§ 371 Date: Jan. 31, 2025

(51) Int. Cl. H04L 25/02; H04B 7/04

(52) U.S. Cl. CPC H04L 25/0224; H04B 7/04013

(57) ABSTRACT

Various aspects of the present disclosure generally relate to wireless communication. In some aspects, a first network node may communicate a reference signal using at least one antenna element disposed at one or more locations on a radio frequency reflection array associated with the first network node. The first network node may communicate with a second network node based at least in part on a characteristic of the reference signal. Numerous other aspects are described.

### FIELD OF THE DISCLOSURE

Aspects of the present disclosure generally relate to wireless communication and to techniques and apparatuses for radio frequency reflection arrays having at least one antenna element.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first network node for wireless communication. The first network node may include a memory and one or more processors coupled to the memory. The one or more processors may be configured to communicate a reference signal using at least one antenna element disposed at one or more locations on a radio frequency reflection array associated with the first network node. The one or more processors may be configured to communicate with a second network node based at least in part on a characteristic of the reference signal.

Some aspects described herein relate to a first network node for wireless communication. The first network node may include a memory and one or more processors coupled to the memory. The one or more processors may be configured to communicate a reference signal corresponding to at least one antenna element disposed at one or more locations on a radio frequency reflection array associated with a second network node. The one or more processors may be configured to communicate with the second network node based at least in part on a characteristic of the reference signal.

Some aspects described herein relate to a method of wireless communication performed by a first network node. The method may include communicating a reference signal using at least one antenna element disposed at one or more locations on a radio frequency reflection array associated with the first network node. The method may include communicating with a second network node based at least in part on a characteristic of the reference signal.

Some aspects described herein relate to a method of wireless communication performed by a first network node. The method may include communicating a reference signal corresponding to at least one antenna element disposed at one or more locations on a radio frequency reflection array associated with a second network node. The method may include communicating with the second network node based at least in part on a characteristic of the reference signal.

Some aspects described herein relate to a non-transitory computer-readable medium that stores a set of instructions for wireless communication by a first network node. The set of instructions, when executed by one or more processors of the first network node, may cause the first network node to communicate a reference signal using at least one antenna element disposed at one or more locations on a radio frequency reflection array associated with the first network node. The set of instructions, when executed by one or more processors of the first network node, may cause the first network node to communicate with a second network node based at least in part on a characteristic of the reference signal.

Some aspects described herein relate to a non-transitory computer-readable medium that stores a set of instructions for wireless communication by a first network node. The set of instructions, when executed by one or more processors of the first network node, may cause the first network node to communicate a reference signal corresponding to at least one antenna element disposed at one or more locations on a radio frequency reflection array associated with a second network node. The set of instructions, when executed by one or more processors of the first network node, may cause the first network node to communicate with the second network node based at least in part on a characteristic of the reference signal.

Some aspects described herein relate to an apparatus for wireless communication. The apparatus may include means for communicating a reference signal using at least one antenna element disposed at one or more locations on a radio frequency reflection array associated with the apparatus. The apparatus may include means for communicating with a network node based at least in part on a characteristic of the reference signal.

Some aspects described herein relate to an apparatus for wireless communication. The apparatus may include means for communicating a reference signal corresponding to at least one antenna element disposed at one or more locations on a radio frequency reflection array associated with a network node. The apparatus may include means for communicating with the network node based at least in part on a characteristic of the reference signal.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open-radio access network architecture, in accordance with the present disclosure.

FIG. 4 is a diagram illustrating an example of multiple input multiple output (MIMO) communications, in accordance with the present disclosure.

FIGS. 5-7 are diagrams illustrating examples associated with radio frequency reflection arrays having at least one antenna element, in accordance with the present disclosure.

FIGS. 8 and 9 are diagrams illustrating example processes associated with radio frequency reflection arrays having at least one antenna element, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

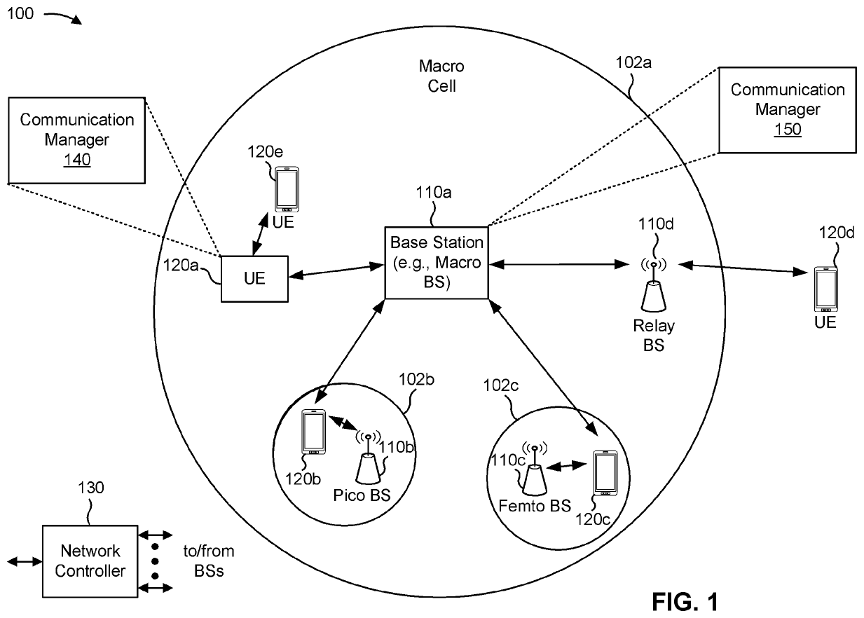

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR 1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which also may be referred to as a “node” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, a first network node may include a communication manager 140 or a communication manager 150. As described in more detail elsewhere herein, the communication manager 140 or 150 may communicate a reference signal using at least one antenna element disposed at one or more locations on a radio frequency reflection array associated with the first network node; and communicate with a second network node based at least in part on a characteristic of the reference signal.

In some aspects, the communication manager 140 or 150 may communicate a reference signal corresponding to at least one antenna element disposed at one or more locations on a radio frequency reflection array associated with a second network node; and communicate with the second network node based at least in part on a characteristic of the reference signal. Additionally, or alternatively, the communication manager 140 or 150 may perform one or more other operations described herein.

As indicated above, FIG. 1 is provided as an example. Other examples may differ from what is described with regard to FIG. 1.

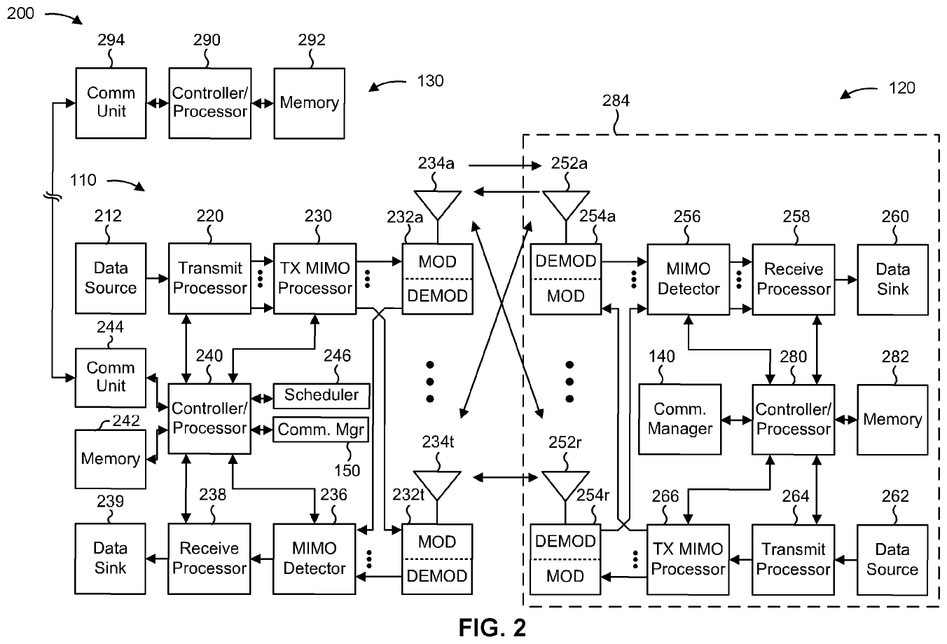

FIG. 2 is a diagram illustrating an example 200 of a base station 110 in communication with a UE 120 in a wireless network 100, in accordance with the present disclosure. The base station 110 may be equipped with a set of antennas 234a through 234t, such as T′ antennas (T′>1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., 7 downlink signals) via a corresponding set of antennas 234 (e.g., 7 antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a centralized unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station.” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station.” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

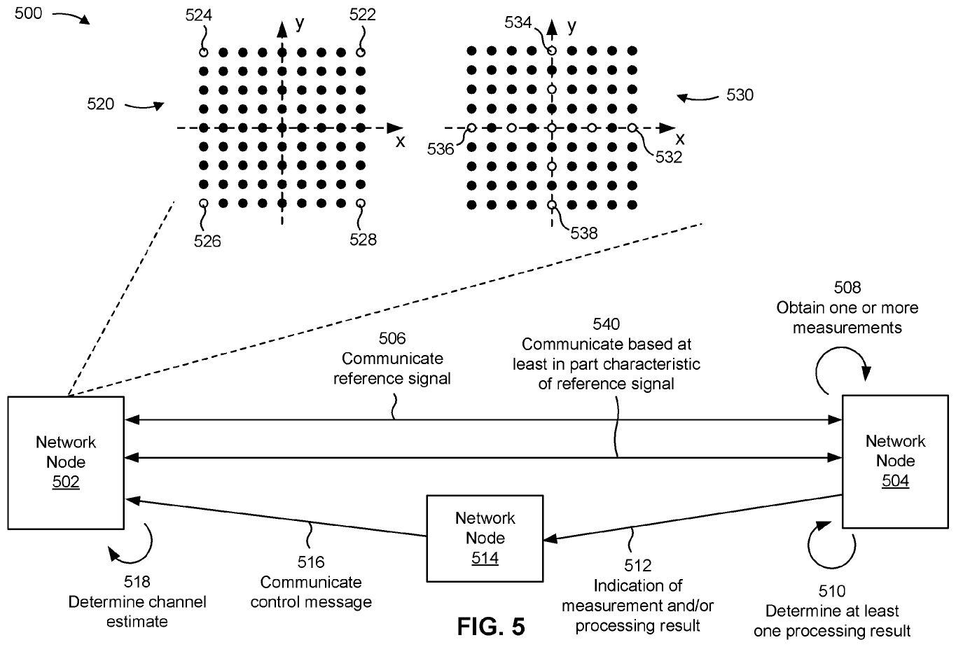

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

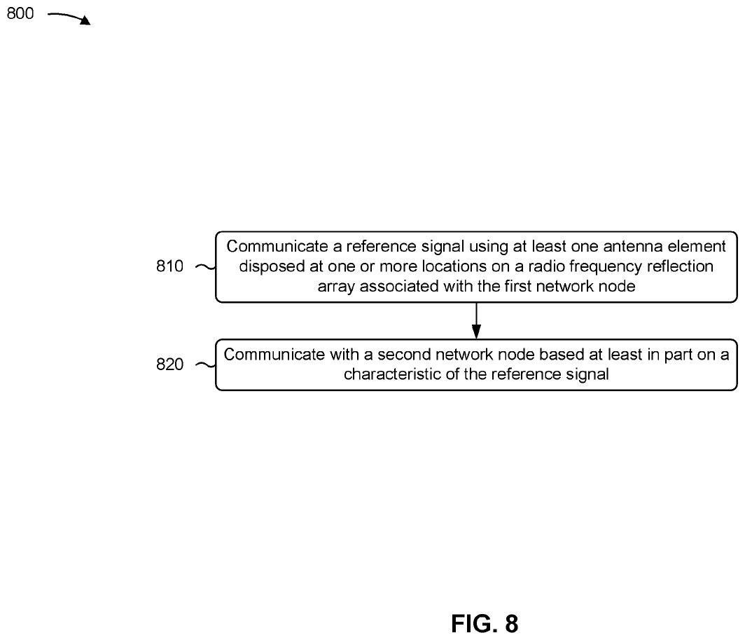

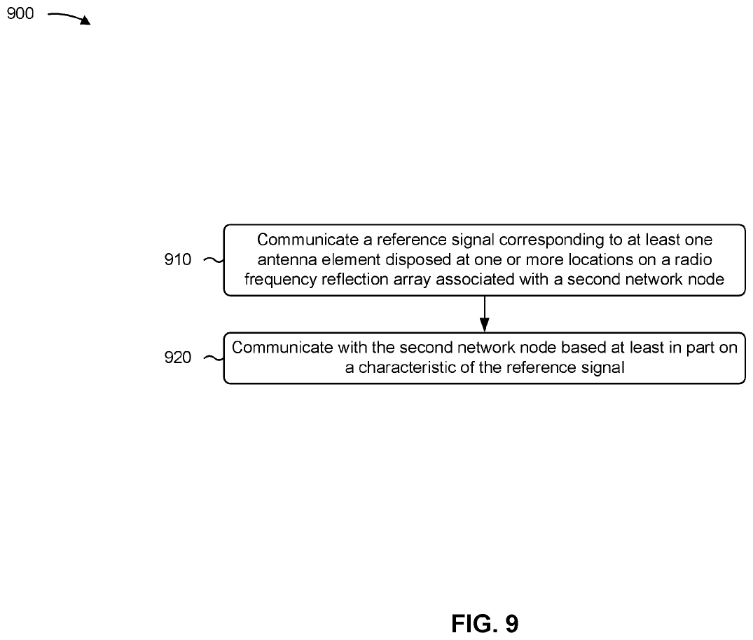

The controller/processor 240 of the base station 110, the controller/processor 280 of the UE 120, and/or any other component(s) of FIG. 2 may perform one or more techniques associated with radio frequency reflection arrays having at least one antenna element, as described in more detail elsewhere herein. In some aspects, the network node described herein is the base station 110, is included in the base station 110, or includes one or more components of the base station 110 shown in FIG. 2. In some aspects, the network node described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a first network node includes means for communicating a reference signal using at least one antenna element disposed at one or more locations on a radio frequency reflection array associated with the first network node; and/or means for communicating with a second network node based at least in part on a characteristic of the reference signal.

In some aspects, the first network node includes means for communicating a reference signal corresponding to at least one antenna element disposed at one or more locations on a radio frequency reflection array associated with a second network node; and/or means for communicating with the second network node based at least in part on a characteristic of the reference signal. In some aspects, the means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the first network node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

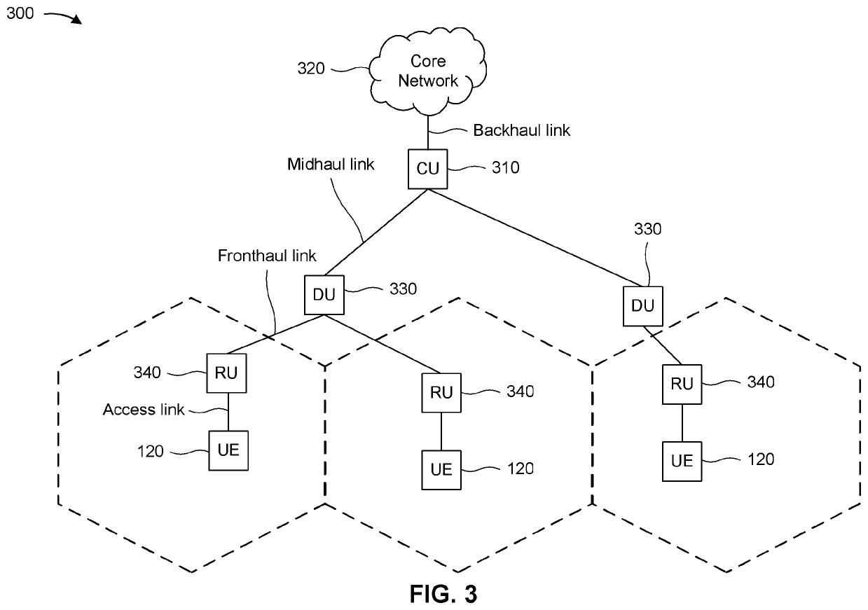

FIG. 3 is a diagram illustrating an example 300 of an O-RAN architecture, in accordance with the present disclosure. As shown in FIG. 3, the O-RAN architecture may include a CU 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via RF access links. The DUs 330 and the RUs 340 may also be referred to as O-RAN DUS (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

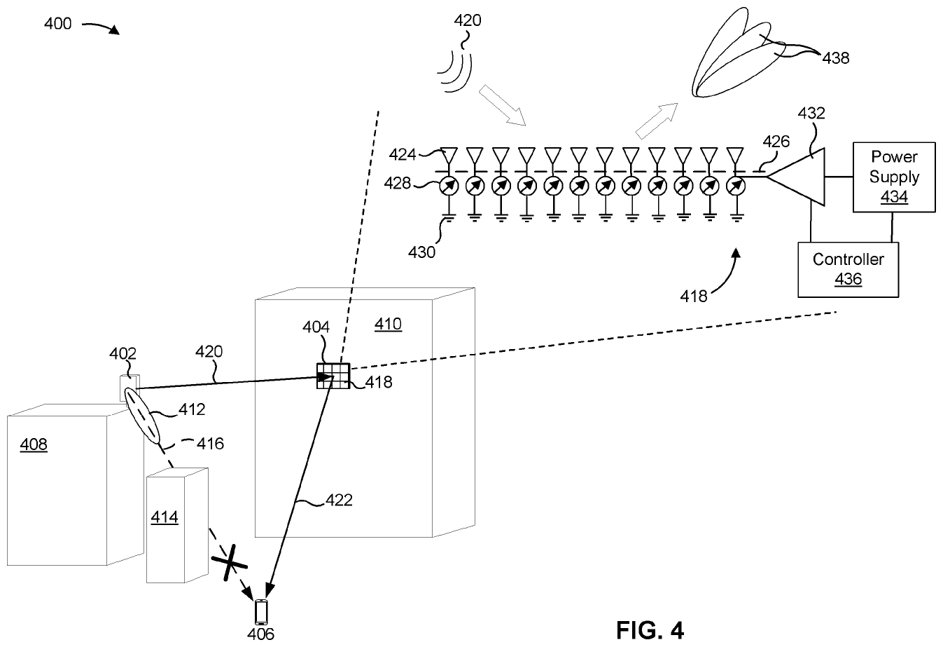

FIG. 4 is a diagram illustrating an example 400 of MIMO communications, in accordance with the present disclosure. As shown, the example 400 includes a network node 402, a network node 404, and a network node 406. The network nodes 402 and 404 are depicted as being mounted on buildings 408 and 410, respectively. In some cases, one or more of the network nodes 402, 404, and/or 406 may include any number of different types of network nodes such as, for example, base stations, relay devices, DUs, RUS, CUs, and/or UEs, among other examples, and may be self-contained, integrated with any number of other different structures and/or devices, and/or mounted on any number of different types of structures (e.g., vehicles, poles, and/or non-terrestrial network devices, among other examples).

As shown, for example, the network node 402 may communicate with the network node 406 (e.g., a UE). In some cases, for example, the network node 402 can include an antenna panel configured for MIMO communications, in which case the network node 402 can communicate with the network node 406 and another network node simultaneously. In some cases, multiple antenna elements of the antenna panel can be configured to direct a beam 412 to the network node 406. Because MIMO antenna panels include multiple antenna elements, the beam 412 can be beamformed so as to be directed to a target (e.g., the network node 406) a certain distance away from the network node 402.

In some cases, an obstruction 414 can block a line-of-sight (LoS) communication 416 (as indicated by the “X” over the communication 416 arrow) between the network node 402 and the network node 406. To facilitate communication with the network node 406, the network node 402 can utilize the network node 404, which can include, for example, a radio frequency reflection array 418 configured to perform radio frequency reflection services. The network node 404 can be, for example, a reconfigurable intelligent surface (RIS) (which also can be referred to as an intelligent reflective surface (IRS)). As shown, for example, the network node 402 can transmit a signal 420 toward the network node 404, which can reflect a reflected signal 422 to the network node 406. In some cases, the reflected signal 422 can be beamformed to be directed specifically at the network node 406.

As shown in FIG. 4, the radio frequency reflection array 418 may include a set of reflecting elements 424 disposed adjacent to a ground plane 426. Each reflecting element 424 can be coupled to a phase shifting component 428, and each phase shifting component 428 can be coupled to a respective grounding component 430. In some aspects, each reflecting element 424 can be coupled to two phase shifting components 428, one for each polarization. In some aspects, one or more reflecting elements 424 can be driven by a power amplifier 432. The power amplifier 432 can be coupled to a power supply 434 and can be controlled by a controller 436. In some cases, for example, the power amplifier 432 can be configured to provide just enough power to offset energy loss due to reflection of a signal and/or phase adjustment thereof. In some cases, a complexity of the controller 436 and/or power consumption by the power amplifier 432 can be based at least in part on selection of phase shifting components 428. In some cases, the radio frequency reflection array 418 can be configured to reflect the signal 420 by beamforming the reflected signal 422 to direct the reflected signal 422 based on one or more beams 438.

Although radio frequency reflection arrays can be deployed transparently to other network nodes such as UEs, a network node-aware radio frequency reflection array can offer benefits such as, for example, providing for control of the radio frequency reflection array by a network node, providing positioning services, and/or beamforming using different types of waves (e.g., spherical waves). In some cases, a total channel transfer function between a first network node and a second network node, via a radio frequency reflection array may be a product of a channel transfer function between the first network node and the radio frequency reflection array and a channel transfer function between the radio frequency reflection array and the second network node. To facilitate efficient and high quality communications, channel estimates can be performed by devices associated with the channel. However, in some cases, radio frequency reflection arrays do not include transmitting and/or receiving antenna elements to facilitate channel estimation.

Some aspects of the techniques and apparatuses described herein may include radio frequency reflection arrays having antenna elements that may be used to transmit and/or receive signals. In this way, the radio frequency reflection array may be configured to facilitate channel estimation at the network node that includes the radio frequency reflection array and/or at another network node in communication with the network node having the radio frequency reflection array. In this way, some aspects may facilitate network node-aware radio frequency reflection arrays, which may facilitate channel estimation for providing improved channels between the radio frequency reflection array and other network nodes. As a result, some aspects may positively impact network performance.

As indicated above, FIG. 4 is provided as an example. Other examples may differ from what is described with regard to FIG. 4.

FIG. 5 is a diagram illustrating an example 500 associated with radio frequency reflection arrays having at least one antenna element, in accordance with the present disclosure. As shown in FIG. 5, a network node 502 and a network node 504 may communicate with one another. In some aspects, the network node 502 may include a radio frequency reflection array having at least one antenna element.

As shown by reference number 506, the network node 502 and/or the network node 504 may communicate a reference signal using at least one antenna element disposed at one or more locations on a radio frequency reflection array associated with the network node 502. In some aspects, “communicate” may refer to transmitting, receiving, and/or processing a signal. For example, in some aspects, the network node 502 may communicate the reference signal based on transmitting the reference signal, while, in some other aspects, the network node 502 may communicate the reference signal by receiving the reference signal.

As shown by reference number 508, for example, the network node 504 may obtain one or more measurements associated with the reference signal. In some aspects, for example, the one or more measurements may be, or include, the characteristic of the reference signal. As shown by reference number 510, the network node 504 may determine at least one processing result. In some aspects, for example, the at least one processing result may be, or include, the characteristic of the reference signal. In some aspects, the at least one processing result may include at least one of a positioning of the network node 504, an angle associated with an orientation of the network node 504 with respect to the network node 502, and/or a channel estimate associated with the reference signal, among other examples.

As shown by reference number 512, the network node 504 may transmit, and a network node 514 may receive, at least one of an indication of a measurement of the one or more measurements or a processing result based at least in part on the one or more measurements. In some aspects, for example, the network node 514 may include a base station and/or a UE that controls the network node 502. As shown by reference number 516, the network node 514 may transmit a control message to the network node 502 based at least in part on the indication of the at least one of the measurement or the processing result. For example, the network node 514 may transmit updated operation parameters (e.g., phase shift values) to the network node 502 to cause the network node 502 to adjust one or more of its reflective elements.

In some aspects, the at least one antenna element may include at least one of a transmitter element or a receiver element. For example, in some aspects, the at least one antenna element may include at least one transmitter element and at least one receiver element. The at least one antenna element may include a transmitter element disposed at a first location of the one or more locations and a receiver element disposed at a second location of the one or more locations. In some aspects, the second location is different from the first location and, in some other aspects, the second location corresponds to the first location.

In some aspects, the network node 502 may communicate the reference signal based on transmitting the reference signal to the network node 504 to facilitate a channel estimation procedure associated with a communication channel between the network node 502 and the network node 504. The network node 502 may include, for example, a base station or a UE. In some aspects, the network node 502 may communicate the reference signal based on transmitting a plurality of radio frequency waves. For example, the network node 502 may transmit a first radio frequency wave based at least in part on a phase reference source and a second radio frequency wave based at least in part on the same phase reference source. In some aspects, the phase reference source may be applied to all of the antenna elements of the network node 502.

In some aspects, as shown by reference number 518, the network node 502 may determine a channel estimate based at least in part on the reference signal. For example, the network node 504 may be a UE and may transmit the reference signal, and the network node 502 may receive the reference signal and determine the channel estimate based at least in part on the reference signal. The channel estimate may correspond to a communication channel between the network node 502 and the network node 504. In some aspects, the network node 502 may communicate a positioning reference signal. For example, the network node 502 may communicate the positioning reference signal using at least four antenna elements.

In some aspects, the at least one antenna element associated with the network node 502 may be individually identifiable by another network node (e.g., the network node 504). In some aspects, for example, the network node 502 may use cyclic shifts of a common sequence to facilitate identification of the network nodes. For example, in some aspects, the network node 502 may transmit the reference signal using a first antenna element based at least in part on applying a first cyclic shift to a sequence and may transmit an additional reference signal using a second antenna element based at least in part on applying a second cyclic shift to the sequence.

In some aspects, the locations of the antenna elements on the reflective array may be based at least in part on a correspondence between the one or more locations and one or more channel estimation metrics that satisfy a channel estimation quality condition. For example, a channel estimation metric may satisfy the channel estimation quality condition based on the metric corresponding to an accuracy of the channel estimation satisfying an accuracy threshold.

FIG. 5 includes a schematic diagram 520 of a reflective array structure, in which the filled circles represent radio frequency reflecting elements and the empty circles represent transmit and/or receive antenna elements. As shown, the antenna elements lie in a plane corresponding to a reference coordinate system having a first central axis extending between a first side and a second side that is parallel to the first side and a second central axis, perpendicular to the first central axis.

In some aspects, four antenna elements (indicated by open circles) may be used to communicate reference signals. For example, the antenna elements to be used may include a first antenna element 522 located at a first corner of the reflective array. A second antenna element 524 may be located at a second corner of the reflective array, a third antenna element 526 may be located at a third corner of the reflective array, and a fourth antenna element 528 may be located at a fourth corner of the reflective array. Although the four antenna elements 522, 524, 526, and 528 being located at the four corners of the reflective array may have the advantage of maximizing the distance among the antenna elements 522, 524, 526, and 528, the four antenna elements 522, 524, 526, and 528 may be located in a rectangle which is larger or smaller than the reflective array with sides of the rectangle parallel to the sides of the rectangular reflective array. For example, the one or more locations associated with the antenna elements 522, 524, 526, and 528 may include a plurality of locations arranged in a rectangular shape, each of the plurality of locations corresponding to a respective corner of the rectangular shape. The size of the rectangular shape may be different than the size of the reflective array. For example, the rectangular shape may be larger than the reflective array, smaller than the reflective array, or the same size as the reflective array. The four antenna elements 522, 524, 526, and 528 may be located in a rectangle even if the reflective array is not rectangular shaped.

In another example, each of the transmit antenna elements to be used to transmit the reference signals may be located on one of the two axes. FIG. 5 includes another schematic diagram 530 of another reflective array structure, in which the open circles represent antenna elements. As shown, a first antenna element 532 to be used to communicate reference signals may be located on the first axis (indicated by “x”) of the reference coordinate system. A second antenna element 534 to be used to communicate reference signals may be located on the second axis (indicated by “y”) of the reference coordinate system. As shown, a third transmit antenna element 536 to be used to communicate reference signals may be located on the x-axis and a fourth antenna element 538 to be used to communicate reference signals may be located on the y-axis. As shown in FIG. 5, additional antenna elements to be used to communicate reference signals may be located on the x-axis and/or the y-axis. In some aspects, an antenna element to be used to communicate reference signals may be located at the origin of the reference system (the intersection of the x-axis and the y-axis).

Arranging the antenna elements to be used to transmit reference signals symmetrically may assist in the predictability of phase differences between reference signals and, therefore, facilitate determination, by the network node 504, of one or more measurements and/or processing results associated with the one or more measurements. In some aspects, the time-frequency resources for the reference signal from each of the plurality of antenna elements may have a pre-defined pattern. Phase noise may cause the relative phase in the transmitted reference signal from each of the plurality of antenna elements to vary randomly with time. Therefore, the time for transmitting each reference signal from each of the plurality of antenna elements should be scheduled close enough to one another to overcome the possible de-correlation from the phase noise. In some aspects, each reference signal may be sufficiently dense in the frequency domain so as to mitigate and/or eliminate phase ambiguity. For example, each reference signal may include a frequency domain density that satisfies a density threshold.

For example, for removing phase ambiguity of multiples of 2π or distance ambiguity of multiple wavelengths, the reference signals may be configured to sample the frequency domain with a density on the order of 10² kilohertz (kHz). In some aspects, the network node 504 may use multiple sub-carriers in the reference signal to remove phase ambiguity. In some aspects, the network node 504 may remove ambiguity in an estimated differential phase or differential distance such as d₁−d₂, although d₁ and d₂ themselves may still have ambiguity.

If the density of the reference signals is not sufficient to remove phase ambiguity, the density of antenna elements within the reflective array may be sufficient to mitigate the phase ambiguity. For example, in some aspects, each antenna element may be spaced apart from each immediately adjacent antenna element by a distance equal to less than half of a wavelength of each reference signal. In some aspects, each reference signal may span an entire available bandwidth to improve the accuracy of phase differential measurement.

As shown by reference number 540, the network node 502 may communicate with the network node 504 based at least in part on a characteristic of the reference signal. In some aspects, for example, the characteristic of the reference signal may include a measurement associated with the reference signal (e.g., a phase measurement, an RSRP, and/or a channel estimate associated with the reference signal, among other examples). In some aspects, the network node 502 and the network node 504 may communicate control information.

As indicated above, FIG. 5 is provided as an example. Other examples may differ from what is described with respect to FIG. 5. For example, in some aspects, the network node 504 may determine whether the network node 504 is within a far-field region with respect to the network node 502 based at least in part on one or more phase difference measurements associated with the plurality of reference signals.

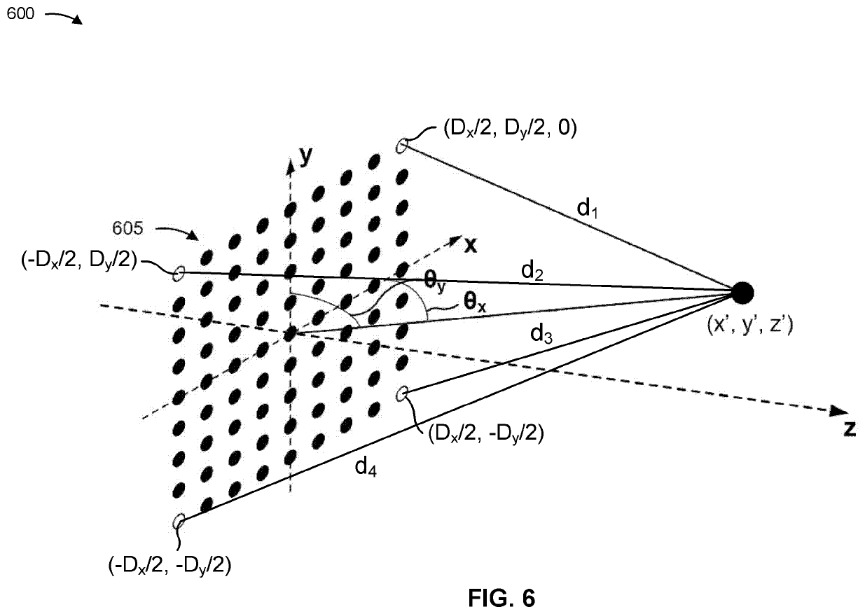

FIG. 6 is a diagram illustrating an example 600 associated with radio frequency reflection arrays having at least one antenna element, in accordance with the present disclosure. As shown in FIG. 6, a radio frequency reflection array 605 may include a number of reflective elements, shown as filled circles, and a number of antenna elements, shown as open circles. The radio frequency reflection array 605 may be, or be similar to, a radio frequency reflection array of the network node 502 shown in FIG. 5. Although the description below describes operations of a receiver having (or using) a single antenna element (represented by the circle at coordinate (x′, y′, z′) and which may be, or be similar to, the network node 504 shown in FIG. 5), the concepts described below may alternatively and similarly apply to operations of a network node having (or using) a plurality of antenna elements receiving reference signals transmitted by a single transmit antenna element.

As described above, the network node 504 may perform an ambiguity removal procedure. In some aspects, for example, the network node 504 may determine whether at least one of a frequency density or a spatial density of reference signal samples satisfies a condition associated with ambiguity mitigation. For example, the ambiguity removal procedure may be based at least in part on determination of a phase difference measurement associated with a reference signal. Determining the phase distance measurement may include determination of position (x′, y′, z′) or angles (θₓ, θ_{y}). For example, in some aspects, a total phase of a reference signal from the antenna element located at

$$( \frac{{D}_{x}}{2} , \frac{{D}_{y}}{2} , 0 )$$

at a first sub-carrier f1 may be given by

$$\frac{2 π {f}_{1} {d}_{1}}{c} = {φ}_{1} ( {f}_{1} ) + {m}_{1 , {f}_{1}} ( 2 π ) ,$$

and a total phase of RS from

$$( - \frac{{D}_{x}}{2} , \frac{{D}_{y}}{2} , 0 )$$

at the sub-carrier f1 may be given by

$$\frac{2 π {f}_{1} {d}_{2}}{c} = {φ}_{2} ( {f}_{1} ) + {m}_{2 , {f}_{1}} ( 2 π ) ,$$

$$where$$

$${φ}_{1} ( {f}_{1} ) - {φ}_{2} ( {f}_{1} ) + ( {m}_{1 , {f}_{1}} - {m}_{2 , {f}_{1}} ) ( 2 π ) = \frac{2 π {f}_{1}}{c} ( {d}_{1} - {d}_{2} ) ,$$

$$and$$

$${φ}_{1} ( {f}_{2} ) - {φ}_{2} ( {f}_{2} ) + {m}_{1 , {f}_{2}} - {m}_{2 , {f}_{2}} ) ( 2 π ) = \frac{2 π {f}_{2}}{c} ( {d}_{1} - {d}_{2} ) ,$$

and
where
d₁ is a distance from the antenna element

$$( \frac{{D}_{x}}{2} , \frac{{D}_{y}}{2} , 0 )$$

on the antenna array to the

$$receiver = \sqrt{{z}^{′2} + {( {x}^{′} - \frac{{D}_{x}}{2} )}^{2} + {( {y}^{′} - \frac{{D}_{y}}{2} )}^{2}} ,$$

and
d₂ is a distance from the antenna element

$$( - \frac{{D}_{x}}{2} , \frac{{D}_{y}}{2} , 0 )$$

on the antenna array to the

$$receiver = \sqrt{{z}^{′2} + {( {x}^{′} - \frac{{D}_{x}}{2} )}^{2} + {( {y}^{′} - \frac{{D}_{y}}{2} )}^{2}} .$$

In some aspects, φ₁(f₁), φ₂(f₁), φ₁(f₂), φ₂(f₂) may be observable by channel estimation based on the reference signal, but the unknown integer multiple of 2π may be resolved by the network node 504. For example, if a multiple of 2π remains in [φ₁(f₁)−φ₂(f₁)]−[φ₁(f₂)−φ₂(f₂)], namely, (m_{1,f}_{₁}−m_{2,f}_{₁})≠(m_{1,f}_{₂}−m_{2,f}_{₂}), this indicates that

$$\vert \frac{2 π}{c} ( {f}_{1} - {f}_{2} ) ( {d}_{1} - {d}_{2} ) \vert \geq 2 π ,$$

which implies

$$\vert ( {d}_{1} - {d}_{2} ) \vert \geq \frac{c}{\vert {f}_{1} - {f}_{2} \vert} .$$

In some aspects, reference signals may be placed densely in the frequency domain. For example, |f₁−f₂| may be on the order of sub-carrier spacing and/or physical resource block size. Accordingly, in some aspects, |f₁−f₂|˜10² kHz, and the corresponding ambiguity length |(d₁−d₂)|˜10³ m, which may be sufficient for phase ambiguity mitigation.

To measure the phase associated with reference signal samples, phase differences may be determined based on solving a system of distance equations. For example, in some aspects, the network node (e.g., network node 504) may perform phase measurement processing to determine, for example, the following distances:
a distance from

$$( \frac{{D}_{x}}{2} , \frac{{D}_{y}}{2} , 0 ) = {d}_{1} = \sqrt{{z}^{′2} + {( {x}^{′} - \frac{{D}_{x}}{2} )}^{2} + {( {y}^{′} - \frac{{D}_{y}}{2} )}^{2}} ,$$

a distance from

$$( - \frac{{D}_{x}}{2} , \frac{{D}_{y}}{2} , 0 ) = {d}_{2} = \sqrt{{z}^{′2} + {( {x}^{′} - \frac{{D}_{x}}{2} )}^{2} + {( {y}^{′} - \frac{{D}_{y}}{2} )}^{2}} ,$$

a distance from

$$( - \frac{{D}_{x}}{2} , - \frac{{D}_{y}}{2} , 0 ) = {d}_{3} = \sqrt{{z}^{′2} + {( {x}^{′} - \frac{{D}_{x}}{2} )}^{2} + {( {y}^{′} - \frac{{D}_{y}}{2} )}^{2}} ,$$

and
a distance from

$$( \frac{{D}_{x}}{2} , - \frac{{D}_{y}}{2} , 0 ) = {d}_{4} = \sqrt{{z}^{′2} + {( {x}^{′} - \frac{{D}_{x}}{2} )}^{2} + {( {y}^{′} - \frac{{D}_{y}}{2} )}^{2}} .$$

These distance functions are nonlinear difficult to determine and accuracy with respect to estimation error may be difficult and, therefore, direct solutions may be to analyze. Thus, the functions may be linearized by Taylor expansion and application of par-axial approximation, as shown below:

$${d}_{1} - {d}_{2} = \text{} \sqrt{{z}^{′2} + {( {x}^{′} - \frac{{D}_{x}}{2} )}^{2} + {( {y}^{′} - \frac{{D}_{y}}{2} )}^{2}} - \sqrt{{z}^{′2} + {( {x}^{′} - \frac{{D}_{x}}{2} )}^{2} + {( {y}^{′} - \frac{{D}_{y}}{2} )}^{2}} \approx {z}^{′} + \frac{{( {x}^{′} - \frac{{D}_{x}}{2} )}^{2} + {( {y}^{′} - \frac{{D}_{y}}{2} )}^{2}}{2 {z}^{′}} - {z}^{′} - \frac{{( {x}^{′} - \frac{{D}_{x}}{2} )}^{2} + {( {y}^{′} - \frac{{D}_{y}}{2} )}^{2}}{2 {z}^{′}} = \text{} - \frac{{x}^{′} {D}_{x}}{{z}^{′}} = - {D}_{x} tan ( {θ}_{x} )$$

Because distance is estimated through phase estimation, in effect, the above operation has kept

$$\frac{{( {x}^{′} + \frac{{D}_{x}}{2} )}^{2}}{λ {z}^{′}} and \frac{{( {y}^{′} - \frac{D y}{2} )}^{2}}{λ {z}^{′}}$$

and ignored

$$\frac{{( {x}^{′} + \frac{{D}_{x}}{2} )}^{4}}{λ {z}^{′3}} and \frac{{( {y}^{′} + \frac{D y}{2} )}^{4}}{λ {z}^{′3}} ,$$

as these terms are satisfied by par-axial approximation. In some aspects, an alternative Taylor expansion may include defining r=\sqrt{z′²+x′²+y′²} and using r in the role of z′ above.

To determine beam format, the network node may perform a solution process by determining:

$${d}_{1} - {d}_{2} \approx - \frac{{x}^{′} {D}_{x}}{{z}^{′}} = - {D}_{x} tan ( {θ}_{x} ) , and$$

$${d}_{1} - {d}_{4} \approx - \frac{{y}^{′} {D}_{y}}{{z}^{′}} = - {D}_{y} tan ( {θ}_{y} ) .$$

Based on the discussion above regarding ambiguity removal, the receiver may assume no integer wavelength ambiguity in d₁−d₂ or d₁−d₄. Accordingly, the network node may solve for tan (θₓ) and tan (θ_{y}), then input the values of x′=z′ tan (θₓ) and y′=z′ tan (θ_{y}) to d₁−d₃ and solve for z′.

After par-axial approximation, z′ only appears in the denominator in the differential phase/distance. Therefore, the accuracy of z′ may be less than the accuracy associated with tan (θₓ) and tan (θ_{y}). In some aspects, parameters concerning tan (θₓ) and tan (θ_{y}), or

$$\frac{{x}^{′}}{{z}^{′}} and \frac{{y}^{′}}{{z}^{′}} ,$$

may be fed back as a whole, and z′ may be fed back individually. Similarly, in some aspects, parameters concerning tan (θₓ) and tan (θ_{y}), or

$$\frac{{x}^{′}}{{z}^{′}} and \frac{{y}^{′}}{{z}^{′}}$$

may result from phase differences across the antenna elements as a linear function of the distance among them (angles of departure). A finite z′ measurement may result in 3D beams with the quadratic terms in the phase. In some aspects, an indication of the accuracy of all of the estimated parameters may be included in the feedback. In some aspects, the receiver may determine the beam format by comparing the estimated distance z′ to a distance threshold.

In some aspects, an alternative Taylor expansion may include defining r=\sqrt{z′²+x′²+y′²} and using r in the role of z′ above. For example, the receiver may determine:

$${d}_{1} = \sqrt{{z}^{′2} + {( {x}^{′} - \frac{{D}_{x}}{2} )}^{2} + {( {y}^{′} - \frac{{D}_{y}}{2} )}^{2}} = \sqrt{{z}^{′2} + {x}^{′2} + {y}^{′2} - {x}^{′} D - {y}^{′} {D}_{x} + \frac{{D}_{x}^{2}}{4} + \frac{{D}_{y}^{2}}{4}} \approx r + \frac{- {x}^{′} {D}_{x} - {y}^{′} {D}_{y} + \frac{{D}_{x}^{2}}{4} + \frac{{D}_{y}^{2}}{4}}{2 r} ,$$

$${d}_{2} \approx r + \frac{{x}^{′} {D}_{x} - {y}^{′} {D}_{y} + \frac{{D}_{x}^{2}}{4} + \frac{{D}_{y}^{2}}{4}}{2 r} ,$$

$${d}_{3} \approx r + \frac{{x}^{′} {D}_{x} - {y}^{′} {D}_{y} + \frac{{D}_{x}^{2}}{4} + \frac{{D}_{y}^{2}}{4}}{2 r} , and$$

$${d}_{4} \approx r + \frac{- {x}^{′} {D}_{x} - {y}^{′} {D}_{y} + \frac{{D}_{x}^{2}}{4} + \frac{{D}_{y}^{2}}{4}}{2 r} .$$

The approximation may also be based on par-axial condition by assuming that

$$\frac{{( x {x}^{′} )}^{2}}{λ {r}^{3}} ≪ 1 , \frac{{x}^{4}}{λ {r}^{3}} ≪ 1.$$

In some aspects,

$$sin {θ}_{x} \frac{{x}^{′}}{r}$$

may be non-negligible to allow wide angular coverage and x˜λ, so

$$\frac{{x}^{2}}{λ r} ≪ 1$$

may be satisfied. In some aspects, the feedback indication may indicate the values of sin (θₓ) and sin (θ_{y}), or

$$\frac{{x}^{′}}{r} and \frac{{y}^{′}}{r} ,$$

and the value of r may be fed back as a separate parameter. The accuracy of all the estimated parameters may be included in the feedback. In some aspects, the receiver may determine the beam format based on a threshold on the estimated r.

As indicated above, FIG. 6 is provided as an example. Other examples may differ from what is described with respect to FIG. 6.

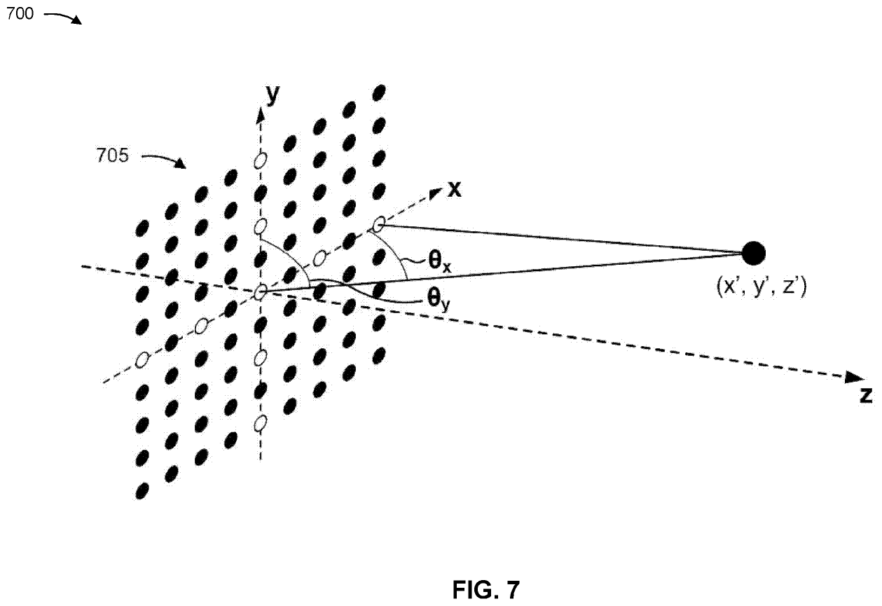

FIG. 7 is a diagram illustrating another example 700 associated with radio frequency reflection arrays having at least one antenna element, in accordance with the present disclosure. As shown in FIG. 7, a radio frequency reflection array 705 may include a number of radio frequency reflective elements, shown as filled circles, and antenna elements, shown as open circles. The radio frequency reflection array 705 may be, or be similar to, a radio frequency reflection array of the network node 502 shown in FIG. 5. Although the description below describes operations of a network node having (or using) a single antenna element (represented by the circle at coordinate (x′, y′, z′) and which may be, or be similar to, the network node 504 shown in FIG. 5), the concepts described below may alternatively and similarly apply to operations of a network node having (or using) a plurality of antenna elements receiving reference signals transmitted by a single transmit antenna elements.

In cases in which the antenna element arrangement is as shown in FIG. 7, the network node may determine that a phase of a reference signal from (0,0,0)—a phase of a reference signal from

$$( x , 0 , 0 ) = \frac{2 π}{λ} \sqrt{{z}^{′2} + {x}^{′2} + {γ}^{′2}} - \frac{2 π}{λ} \sqrt{{z}^{′2} + {( {x}^{′} - x )}^{2} + {y}^{′2}} .$$

If r=\sqrt{z′²+x′²+y′²}, then the phase of the reference signal from (0,0,0)—the phase of the reference signal from

$$( x , 0 , 0 ) = \text{} \frac{2 π}{λ} ( r - \sqrt{{z}^{′2} + {( {x}^{′} - x )}^{2} + {y}^{′2}} ) = \frac{2 π}{λ} ( r - \sqrt{{r}^{2} - 2 {xx}^{′} + {x}^{2}} ) \approx \frac{2 π}{λ} ( \frac{{xx}^{′}}{r} - \frac{{x}^{2}}{2 r} ) .$$

In some aspects, the receiver may determine that the phase of the reference signal from (0,0,0)—the phase of the reference signal from

$$( x , 0 , 0 ) \approx \frac{2 π}{λ} ( \frac{{xx}^{′}}{r} - \frac{{x}^{2}}{2 r} ) , where sin {θ}_{x} = \frac{{x}^{′}}{r}$$

may be non-negligible. To mitigate phase ambiguity, the network node may use multi-frequency reference signal and phase estimation and/or the distance between the adjacent transmitters may be less than the wavelength λ.

In some aspects, the network node may determine whether the network node is located in a far field of the radio frequency reflection array 705. For example, in cases in which the a radio frequency reflection array 705 is arranged as shown in FIG. 7, the network node receiving a transmission from the a radio frequency reflection array 705 may identify whether it is in the far-field region (z′ or r very large) by determining that the phase of the reference signal from (0,0,0)—the phase of the reference signal from

$$( x , 0 , 0 ) \approx \frac{2 π}{λ} ( \frac{{xx}^{′}}{r} - \frac{{x}^{2}}{2 r} ) .$$

The network node may run a linear regression of the phase difference against x and x² and determine that if a confidence interval of the slope of x² does not contain 0, the network node is in the near field. The network node may continue to calculate y′ and z′ from r and identify a spherical wave converging to (x′,y′,z′). In this case, the phase for a radio frequency reflection array 705 transmitting at (x,y,0) may be determined to be

$$exp [ - \frac{i 2 π [ {( x - {x}^{′} )}^{2} + {( y - {y}^{′} )}^{2} ]}{2 λ {z}^{′}} ] ,$$

where if the confidence interval of the slope of x² contains 0, the receiver is in the far field. In that case, the receiver may obtain an estimation of (θₓ, θ_{y}) with

$$sin {θ}_{x} = \frac{{x}^{′}}{r} and sin {θ}_{y} = \frac{{y}^{′}}{r} ,$$

forming a plane wave to the estimated direction, and may determine that the phase for a transmitter at (x,y,0) is given by

$$exp [ - \frac{i π}{λ} ( x sin {θ}_{x} + y sin {θ}_{y} ) ] .$$

In some aspects, the network node may use a regression-type estimation of differential distance. For example, the distance may be calculated based on observed phase and phase difference:

$${φ}_{1} ( {f}_{1} ) - {φ}_{2} ( {f}_{1} ) + ( {m}_{1 , {f}_{1}} - {m}_{2 , {f}_{1}} ) ( 2 π ) = \frac{2 π {f}_{1}}{c} ( {d}_{1} - {d}_{2} ) ,$$

where phase difference is frequency dependent and phase difference at multiple frequencies may be combined to calculate differential distance. In some aspects, the linear-regression type of algorithm can be used to utilize measurement at all sub-carriers with reference signal.

As indicated above, FIG. 7 is provided as an example. Other examples may differ from what is described with respect to FIG. 7. In some aspects, for example, the one or more locations associated with the at least one antenna element may include a first plurality of antenna elements distributed along a first axis and a second plurality of elements distributed along a second axis that is perpendicular to the first axis. For example, the multiple antenna elements may be located in two perpendicular axes even if the reflective array is not rectangular shaped. The antenna elements may not be distributed only across a length which is shorter than the length of the axis from one side to the other side of the reflective array. At least one of the one or more locations may be disposed outside of a boundary of the reflective array. For example, the antenna elements may be distributed across a length that is longer than the length of an axis of the reflective array.

FIG. 8 is a diagram illustrating an example process 800 performed, for example, by a first network node, in accordance with the present disclosure. Example process 800 is an example where the first network node (e.g., network node 502) performs operations associated with radio frequency reflection arrays having at least one antenna element.

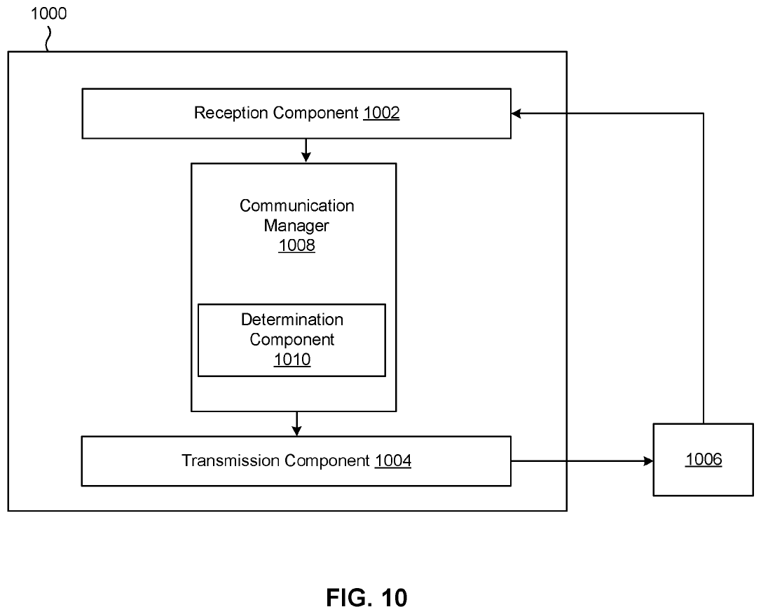

As shown in FIG. 8, in some aspects, process 800 may include communicating a reference signal using at least one antenna element disposed at one or more locations on a radio frequency reflection array associated with the first network node (block 810). For example, the first network node (e.g., using communication manager 1008, reception component 1002, and/or transmission component 1004, depicted in FIG. 10) may communicate a reference signal using at least one antenna element disposed at one or more locations on a radio frequency reflection array associated with the first network node, as described above.

As further shown in FIG. 8, in some aspects, process 800 may include communicating with a second network node based at least in part on a characteristic of the reference signal (block 820). For example, the first network node (using communication manager 1008, reception component 1002, and/or transmission component 1004, depicted in FIG. 10) may communicate with a second network node based at least in part on a characteristic of the reference signal, as described above.

Process 800 may include additional aspects, such as any single aspect or any combination of aspects described below and/or in connection with one or more other processes described elsewhere herein.

In a first aspect, the at least one antenna element comprises at least one of a transmitter element or a receiver element. In a second aspect, alone or in combination with the first aspect, the at least one antenna element comprises at least one transmitter element and at least one receiver element. In a third aspect, alone or in combination with one or more of the first and second aspects, the at least one antenna element comprises a transmitter element disposed at a first location of the one or more locations and a receiver element disposed at a second location of the one or more locations In a fourth aspect, alone or in combination with the third aspect, the second location is different from the first location. In a fifth aspect, alone or in combination with the third aspect, the second location corresponds to the first location.

In a sixth aspect, alone or in combination with one or more of the first through fifth aspects, communicating the reference signal comprises transmitting the reference signal to a UE to facilitate a channel estimation procedure associated with a communication channel between the first network node and the UE. In a seventh aspect, alone or in combination with one or more of the first through sixth aspects, communicating the reference signal comprises transmitting the reference signal to a second network node to facilitate a channel estimation procedure associated with a communication channel between the first network node and the second network node.

In an eighth aspect, alone or in combination with one or more of the first through seventh aspects, communicating the reference signal comprises transmitting a plurality of radio frequency waves, wherein transmitting the plurality of radio frequency waves comprises transmitting a first radio frequency wave based at least in part on a phase reference source and transmitting a second radio frequency wave based at least in part on the phase reference source. In a ninth aspect, alone or in combination with one or more of the first through eighth aspects, communicating the reference signal comprises receiving the reference signal from a UE, the method further comprising determining, based at least in part on the reference signal, a channel estimate associated with a communication channel between the first network node and the UE.

In a tenth aspect, alone or in combination with one or more of the first through ninth aspects, communicating the reference signal comprises receiving the reference signal from the second network node, the method further comprising determining, based at least in part on the reference signal, a channel estimate associated with a communication channel between the first network node and the second network node. In an eleventh aspect, alone or in combination with one or more of the first through tenth aspects, communicating the reference signal comprises receiving a plurality of radio frequency waves, wherein receiving the plurality of radio frequency waves comprises receiving a first radio frequency wave based at least in part on a phase reference source and receiving a second radio frequency wave based at least in part on the phase reference source.

In a twelfth aspect, alone or in combination with one or more of the first through eleventh aspects, the at least one antenna element is individually identifiable by a user equipment. In a thirteenth aspect, alone or in combination with the twelfth aspect, communicating the reference signal comprises communicating the reference signal using a first antenna element of the at least one antenna element and based at least in part on applying a first cyclic shift to a sequence, the method further comprising communicating an additional reference signal using a second antenna element of the at least one antenna element and based at least in part on applying a second cyclic shift to the sequence.

In a fourteenth aspect, alone or in combination with one or more of the first through thirteenth aspects, the one or more locations are based at least in part on a correspondence between the one or more locations and one or more channel estimation metrics that satisfy a channel estimation quality condition. In a fifteenth aspect, alone or in combination with one or more of the first through fourteenth aspects, the radio frequency reflection array comprises a rectangular structure having four corners, and wherein the one or more locations correspond to one or more of the four corners. In a sixteenth aspect, alone or in combination with the fifteenth aspect, the one or more locations correspond to each of the four corners.

In a seventeenth aspect, alone or in combination with one or more of the first through sixteenth aspects, the radio frequency reflection array comprises a rectangular structure comprising a first central axis extending between a first side and a second side that is parallel to the first side, and a second central axis, perpendicular to the first central axis, wherein the one or more locations include at least one of a location along the first central axis or a location along the second central axis. In an eighteenth aspect, alone or in combination with one or more of the first through seventeenth aspects, communicating with the second network node comprises communicating control information. In a nineteenth aspect, alone or in combination with one or more of the first through eighteenth aspects, the reference signal comprises a positioning reference signal, and wherein communicating the reference signal comprises communicating the positioning reference signal using at least four antenna elements of the at least one antenna element.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a first network node, in accordance with the present disclosure. Example process 900 is an example where the first network node (e.g., network node 504) performs operations associated with radio frequency reflection arrays having at least one antenna element.

As shown in FIG. 9, in some aspects, process 900 may include communicating a reference signal corresponding to at least one antenna element disposed at one or more locations on a radio frequency reflection array associated with a second network node (block 910). For example, the first network node (using communication manager 1008, reception component 1002, and/or transmission component 1004, depicted in FIG. 10) may communicate a reference signal corresponding to at least one antenna element disposed at one or more locations on a radio frequency reflection array associated with a second network node, as described above.

As further shown in FIG. 9, in some aspects, process 900 may include communicating with the second network node based at least in part on a characteristic of the reference signal (block 920). For example, the first network node (using communication manager 1008, reception component 1002, and/or transmission component 1004, depicted in FIG. 10) may communicate with the second network node based at least in part on a characteristic of the reference signal, as described above.

Process 900 may include additional aspects, such as any single aspect or any combination of aspects described below and/or in connection with one or more other processes described elsewhere herein.

In a first aspect, the at least one antenna element comprises at least one of a transmitter element or a receiver element. In a second aspect, alone or in combination with the first aspect, the at least one antenna element comprises at least one transmitter element and at least one receiver element. In a third aspect, alone or in combination with one or more of the first and second aspects, the at least one antenna element comprises a transmitter element disposed at a first location of the one or more locations and a receiver element disposed at a second location of the one or more locations. In a fourth aspect, alone or in combination with the third aspect, the second location is different from the first location. In a fifth aspect, alone or in combination with the third aspect, the second location corresponds to the first location.

In a sixth aspect, alone or in combination with one or more of the first through fifth aspects, communicating the reference signal comprises receiving the reference signal, the method further comprising performing a channel estimation procedure associated with a communication channel between the first network node and the second network node. In a seventh aspect, alone or in combination with one or more of the first through sixth aspects, communicating the reference signal comprises receiving a plurality of radio frequency waves, wherein receiving the plurality of radio frequency waves comprises receiving a first radio frequency wave based at least in part on a phase reference source and receiving a second radio frequency wave based at least in part on the phase reference source. In an eighth aspect, alone or in combination with one or more of the first through seventh aspects, communicating the reference signal comprises transmitting a plurality of radio frequency waves, wherein transmitting the plurality of radio frequency waves comprises transmitting a first radio frequency wave based at least in part on a phase reference source and transmitting a second radio frequency wave based at least in part on the phase reference source.

In a ninth aspect, alone or in combination with one or more of the first through eighth aspects, the at least one antenna element is individually identifiable by the first network node. In a tenth aspect, alone or in combination with the ninth aspect, communicating the reference signal comprises communicating the reference signal corresponding to a first antenna element of the at least one antenna element and based at least in part on an application of a first cyclic shift to a sequence, the method further comprising communicating an additional reference signal corresponding to a second antenna element of the at least one antenna element and based at least in part on an application of a second cyclic shift to the sequence.

In an eleventh aspect, alone or in combination with one or more of the first through tenth aspects, the one or more locations are based at least in part on a correspondence between the one or more locations and one or more channel estimation metrics that satisfy a channel estimation quality condition. In a twelfth aspect, alone or in combination with one or more of the first through eleventh aspects, communicating with the second network node comprises communicating control information. In a thirteenth aspect, alone or in combination with one or more of the first through twelfth aspects, the reference signal comprises a positioning reference signal, and wherein communicating the reference signal comprises communicating the positioning reference signal corresponding to at least four antenna elements of the at least one antenna element.

In a fourteenth aspect, alone or in combination with one or more of the first through thirteenth aspects, communicating the reference signal comprises receiving the reference signal, the method further comprising obtaining one or more measurements associated with the reference signal. In a fifteenth aspect, alone or in combination with the fourteenth aspect, the one or more measurements indicate at least one carrier phase associated with the at least one antenna element. In a sixteenth aspect, alone or in combination with the fifteenth aspect, process 900 includes transmitting, to a third network node, at least one of an indication of a measurement of the one or more measurements or a processing result based at least in part on the one or more measurements. In a seventeenth aspect, alone or in combination with the sixteenth aspect, process 900 includes determining the at least one processing result, wherein the at least one processing result indicates at least one of a position of the first network node or an angle associated with an orientation of the first network node with respect to the second network node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008. The communication manager 1008 may include a determination component 1010.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE or the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE or the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE or the base station described in connection with FIG. 2. In some aspects, the transmission component 1004 may be co-located with the reception component 1002 in a transceiver.

The communication manager 1008, the reception component 1002, and/or the transmission component 1004 may communicate a reference signal using at least one antenna element disposed at one or more locations on a radio frequency reflection array associated with the first network node. The communication manager 1008, the reception component 1002, and/or the transmission component 1004 may communicate with a second network node based at least in part on a characteristic of the reference signal. In some aspects, the communication manager 1008 may include one or more antennas, a modem, a controller/processor, a memory, or a combination thereof, of the UE or the base station described in connection with FIG. 2. In some aspects, the communication manager 1008 may be, be similar to, include, or be included in, the communication manager 140 or the communication manager 150, depicted in FIGS. 1 and 2. In some aspects, the communication manager 1008 may include the reception component 1002 and/or the transmission component 1004.

The communication manager 1008, the reception component 1002, and/or the transmission component 1004 may communicate a reference signal corresponding to at least one antenna element disposed at one or more locations on a radio frequency reflection array associated with a second network node. The communication manager 1008, the reception component 1002, and/or the transmission component 1004 may communicate with the second network node based at least in part on a characteristic of the reference signal. The transmission component 1004 may transmit, to a third network node, at least one of an indication of a measurement of the one or more measurements or a processing result based at least in part on the one or more measurements.

The determination component 1010 may determine the at least one processing result, wherein the at least one processing result indicates at least one of a position of the first network node or an angle associated with an orientation of the first network node with respect to the second network node. In some aspects, the determination component 1010 may include one or more antennas, a modem, a controller/processor, a memory, or a combination thereof, of the UE or the base station described in connection with FIG. 2. In some aspects, the determination component 1010 may include the reception component 1002 and/or the transmission component 1004.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a first network node, comprising: communicating a reference signal using at least one antenna element disposed at one or more locations on a radio frequency reflection array associated with the first network node; and communicating with a second network node based at least in part on a characteristic of the reference signal.
Aspect 2: The method of Aspect 1, wherein the at least one antenna element comprises at least one of a transmitter element or a receiver element.
Aspect 3: The method of either of Aspects 1 or 2, wherein the at least one antenna element comprises at least one transmitter element and at least one receiver element.
Aspect 4: The method of any of Aspects 1-3, wherein the at least one antenna element comprises a transmitter element disposed at a first location of the one or more locations and a receiver element disposed at a second location of the one or more locations.
Aspect 5: The method of Aspect 4, wherein the second location is different from the first location.
Aspect 6: The method of Aspect 4, wherein the second location corresponds to the first location.
Aspect 7: The method of any of Aspects 1-6, wherein communicating the reference signal comprises transmitting the reference signal to a user equipment (UE) to facilitate a channel estimation procedure associated with a communication channel between the first network node and the UE.
Aspect 8: The method of any of Aspects 1-7, wherein communicating the reference signal comprises transmitting the reference signal to a second network node to facilitate a channel estimation procedure associated with a communication channel between the first network node and the second network node.
Aspect 9: The method of any of Aspects 1-8, wherein communicating the reference signal comprises transmitting a plurality of radio frequency waves, wherein transmitting the plurality of radio frequency waves comprises transmitting a first radio frequency wave based at least in part on a phase reference source and transmitting a second radio frequency wave based at least in part on the phase reference source.
Aspect 10: The method of any of Aspects 1-9, wherein communicating the reference signal comprises receiving the reference signal from a user equipment (UE), the method further comprising determining, based at least in part on the reference signal, a channel estimate associated with a communication channel between the first network node and the UE.
Aspect 11: The method of any of Aspects 1-10, wherein communicating the reference signal comprises receiving the reference signal from the second network node, the method further comprising determining, based at least in part on the reference signal, a channel estimate associated with a communication channel between the first network node and the second network node.
Aspect 12: The method of any of Aspects 1-11, wherein communicating the reference signal comprises receiving a plurality of radio frequency waves, wherein receiving the plurality of radio frequency waves comprises receiving a first radio frequency wave based at least in part on a phase reference source and receiving a second radio frequency wave based at least in part on the phase reference source.
Aspect 13: The method of any of Aspects 1-12, wherein the at least one antenna element is individually identifiable by a user equipment.
Aspect 14: The method of Aspect 13, wherein communicating the reference signal comprises communicating the reference signal using a first antenna element of the at least one antenna element and based at least in part on applying a first cyclic shift to a sequence, the method further comprising communicating an additional reference signal using a second antenna element of the at least one antenna element and based at least in part on applying a second cyclic shift to the sequence.
Aspect 15: The method of any of Aspects 1-14, wherein the one or more locations are based at least in part on a correspondence between the one or more locations and one or more channel estimation metrics that satisfy a channel estimation quality condition.
Aspect 16: The method of any of Aspects 1-15, wherein the radio frequency reflection array comprises a rectangular structure having four corners, and wherein the one or more locations correspond to one or more of the four corners.
Aspect 17: The method of Aspect 16, wherein the one or more locations correspond to each of the four corners.
Aspect 18: The method of any of Aspects 1-17, wherein the radio frequency reflection array comprises a rectangular structure comprising: a first central axis extending between a first side and a second side that is parallel to the first side; and a second central axis, perpendicular to the first central axis, wherein the one or more locations include at least one of a location along the first central axis or a location along the second central axis.
Aspect 19: The method of any of Aspects 1-18, wherein communicating with the second network node comprises communicating control information.
Aspect 20: The method of any of Aspects 1-19, wherein the reference signal comprises a positioning reference signal, and wherein communicating the reference signal comprises communicating the positioning reference signal using at least four antenna elements of the at least one antenna element.
Aspect 21: The method of any of Aspects 1-20, wherein the one or more locations include a plurality of locations arranged in a rectangular shape, each of the plurality of locations corresponding to a respective corner of the rectangular shape.
Aspect 22: The method of Aspect 21, wherein a size of the rectangular shape is different than a size of the reflective array.
Aspect 23: The method of any of Aspects 1-22, wherein the one or more locations include a first plurality of antenna elements distributed along a first axis and a second plurality of elements distributed along a second axis that is perpendicular to the first axis
Aspect 24: The method of any of claims 1-23, wherein at least one of the one or more locations is disposed outside of a boundary of the reflective array.
Aspect 25: A method of wireless communication performed by a first network node, comprising: communicating a reference signal corresponding to at least one antenna element disposed at one or more locations on a radio frequency reflection array associated with a second network node; and communicating with the second network node based at least in part on a characteristic of the reference signal.
Aspect 26: The method of Aspect 25, wherein the at least one antenna element comprises at least one of a transmitter element or a receiver element.
Aspect 27: The method of either of Aspects 25 or 26, wherein the at least one antenna element comprises at least one transmitter element and at least one receiver element.
Aspect 28: The method of any of Aspects 25-27, wherein the at least one antenna element comprises a transmitter element disposed at a first location of the one or more locations and a receiver element disposed at a second location of the one or more locations.
Aspect 29: The method of Aspect 28, wherein the second location is different from the first location.
Aspect 30: The method of Aspect 28, wherein the second location corresponds to the first location.
Aspect 31: The method of any of Aspects 25-30, wherein communicating the reference signal comprises receiving the reference signal, the method further comprising performing a channel estimation procedure associated with a communication channel between the first network node and the second network node.
Aspect 32: The method of any of Aspects 25-31, wherein communicating the reference signal comprises receiving a plurality of radio frequency waves, wherein receiving the plurality of radio frequency waves comprises receiving a first radio frequency wave based at least in part on a phase reference source and receiving a second radio frequency wave based at least in part on the phase reference source.
Aspect 33: The method of any of Aspects 25-32, wherein communicating the reference signal comprises transmitting a plurality of radio frequency waves, wherein transmitting the plurality of radio frequency waves comprises transmitting a first radio frequency wave based at least in part on a phase reference source and transmitting a second radio frequency wave based at least in part on the phase reference source.
Aspect 34: The method of any of Aspects 25-33, wherein the at least one antenna element is individually identifiable by the first network node.
Aspect 35: The method of Aspect 34, wherein communicating the reference signal comprises communicating the reference signal corresponding to a first antenna element of the at least one antenna element and based at least in part on an application of a first cyclic shift to a sequence, the method further comprising communicating an additional reference signal corresponding to a second antenna element of the at least one antenna element and based at least in part on an application of a second cyclic shift to the sequence.
Aspect 36: The method of any of Aspects 25-35, wherein the one or more locations are based at least in part on a correspondence between the one or more locations and one or more channel estimation metrics that satisfy a channel estimation quality condition.
Aspect 37: The method of any of Aspects 25-36, wherein communicating with the second network node comprises communicating control information.
Aspect 38: The method of any of Aspects 25-37, wherein the reference signal comprises a positioning reference signal, and wherein communicating the reference signal comprises communicating the positioning reference signal corresponding to at least four antenna elements of the at least one antenna element.
Aspect 39: The method of any of Aspects 25-38, wherein communicating the reference signal comprises receiving the reference signal, the method further comprising obtaining one or more measurements associated with the reference signal.
Aspect 40: The method of Aspect 39, wherein the one or more measurements indicate at least one carrier phase associated with the at least one antenna element.
Aspect 41: The method of Aspect 40, further comprising transmitting, to a third network node, at least one of an indication of a measurement of the one or more measurements or a processing result based at least in part on the one or more measurements.
Aspect 42: The method of Aspect 41, further comprising determining the at least one processing result, wherein the at least one processing result indicates at least one of a position of the first network node or an angle associated with an orientation of the first network node with respect to the second network node.
Aspect 43: The method of any of Aspects 25-42, wherein the one or more locations include a plurality of locations arranged in a rectangular shape, each of the plurality of locations corresponding to a respective corner of the rectangular shape.
Aspect 44: The method of Aspect 43, wherein a size of the rectangular shape is different than a size of the reflective array.
Aspect 45: The method of any of Aspects 25-44, wherein the one or more locations include a first plurality of antenna elements distributed along a first axis and a second plurality of elements distributed along a second axis that is perpendicular to the first axis
Aspect 46: The method of any of claims 25-45, wherein at least one of the one or more locations is disposed outside of a boundary of the reflective array.
Aspect 47: An apparatus for wireless communication at a device, comprising a processor; memory coupled with the processor; and instructions stored in the memory and executable by the processor to cause the apparatus to perform the method of one or more of Aspects 1-24.
Aspect 48: A device for wireless communication, comprising a memory and one or more processors coupled to the memory, the one or more processors configured to perform the method of one or more of Aspects 1-24.
Aspect 49: An apparatus for wireless communication, comprising at least one means for performing the method of one or more of Aspects 1-24.
Aspect 50: A non-transitory computer-readable medium storing code for wireless communication, the code comprising instructions executable by a processor to perform the method of one or more of Aspects 1-24.
Aspect 51: A non-transitory computer-readable medium storing a set of instructions for wireless communication, the set of instructions comprising one or more instructions that, when executed by one or more processors of a device, cause the device to perform the method of one or more of Aspects 1-24.
Aspect 52: An apparatus for wireless communication at a device, comprising a processor; memory coupled with the processor; and instructions stored in the memory and executable by the processor to cause the apparatus to perform the method of one or more of Aspects 25-46.
Aspect 53: A device for wireless communication, comprising a memory and one or more processors coupled to the memory, the one or more processors configured to perform the method of one or more of Aspects 25-46.
Aspect 54: An apparatus for wireless communication, comprising at least one means for performing the method of one or more of Aspects 25-46.
Aspect 55: A non-transitory computer-readable medium storing code for wireless communication, the code comprising instructions executable by a processor to perform the method of one or more of Aspects 25-46.
Aspect 56: A non-transitory computer-readable medium storing a set of instructions for wireless communication, the set of instructions comprising one or more instructions that, when executed by one or more processors of a device, cause the device to perform the method of one or more of Aspects 25-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A first network node for wireless communication, comprising:
a memory; and
one or more processors, coupled to the memory, configured to:
communicate a reference signal using at least one antenna element dis-posed at one or more locations on a radio frequency reflection array associated with the first network node; and
communicate with a second network node based at least in part on a characteristic of the reference signal.

2. The first network node of claim 1, wherein the at least one antenna element comprises at least one of a transmitter element or a receiver element.

3. The first network node of claim 1, wherein the at least one antenna element comprises at least one transmitter element and at least one receiver element.

4. The first network node of claim 1, wherein the at least one antenna element comprises a transmitter element disposed at a first location of the one or more locations and a receiver element disposed at a second location of the one or more locations.

5. The first network node of claim 4, wherein the second location is different from the first location.

6. (canceled)

7. The first network node of claim 1, wherein the one or more processors, to communicate the reference signal, are configured to transmit the reference signal to a user equipment (UE) to facilitate a channel estimation procedure associated with a communication channel between the first network node and the UE.

8. The first network node of claim 1, wherein the one or more processors, to communicate the reference signal, are configured to transmit the reference signal to a second network node to facilitate a channel estimation procedure associated with a communication channel between the first network node and the second network node.

9. The first network node of claim 1, wherein the one or more processors, to communicate the reference signal, are configured to transmit a plurality of radio frequency waves, and wherein the one or more processors, to transmit the plurality of radio frequency waves, are configured to transmit a first radio frequency wave based at least in part on a phase reference source and transmit a second radio frequency wave based at least in part on the phase reference source.

10. The first network node of claim 1, wherein the one or more processors, to communicate the reference signal, are configured to receive the reference signal from a user equipment (UE), and wherein the one or more processors are further configured to determine, based at least in part on the reference signal, a channel estimate associated with a communication channel between the first network node and the UE.

11. The first network node of claim 1, wherein the one or more processors, to communicate the reference signal, are configured to receive the reference signal from the second network node, and wherein the one or more processors are further configured to determine, based at least in part on the reference signal, a channel estimate associated with a communication channel between the first network node and the second network node.

12. The first network node of claim 1, wherein the one or more processors, to communicate the reference signal, are configured to receive a plurality of radio frequency waves, and wherein the one or more processors, to receive the plurality of radio frequency waves, are configured to receive a first radio frequency wave based at least in part on a phase reference source and receiving a second radio frequency wave based at least in part on the phase reference source.

13. (canceled)

14. The first network node of claim 13, wherein the one or more processors, to communicate the reference signal, are configured to communicate the reference signal using a first antenna element of the at least one antenna element and based at least in part on applying a first cyclic shift to a sequence, and wherein the one or more processors are further configured to communicate an additional reference signal using a second antenna element of the at least one antenna element and based at least in part on applying a second cyclic shift to the sequence.

15. The first network node of claim 1, wherein the one or more locations are based at least in part on a correspondence between the one or more locations and one or more channel estimation metrics that satisfy a channel estimation quality condition.

16. The first network node of claim 1, wherein the radio frequency reflection array comprises a rectangular structure having four corners, and wherein the one or more locations correspond to one or more of the four corners.

17. (canceled)

18. The first network node of claim 1, wherein the radio frequency reflection array comprises a rectangular structure comprising:
a first central axis extending between a first side and a second side that is parallel to the first side; and
a second central axis, perpendicular to the first central axis, wherein the one or more locations include at least one of a location along the first central axis or a location along the second central axis.

19. (canceled)

20. The first network node of claim 1, wherein the reference signal comprises a positioning reference signal, and wherein the one or more processors, to communicate the reference signal, are configured to communicate the positioning reference signal using at least four antenna elements of the at least one antenna element.

21. The first network node of claim 1, wherein the one or more locations include a plurality of locations arranged in a rectangular shape, each of the plurality of locations corresponding to a respective corner of the rectangular shape.

22. (canceled)

23. The first network node of claim 1, wherein the one or more locations include a first plurality of antenna elements distributed along a first axis and a second plurality of elements distributed along a second axis that is perpendicular to the first axis.

24. (canceled)

25. A first network node for wireless communication, comprising:
a memory; and
one or more processors, coupled to the memory, configured to:
communicate a reference signal corresponding to at least one antenna element disposed at one or more locations on a radio frequency reflection array associated with a second network node; and
communicate with the second network node based at least in part on a characteristic of the reference signal.

26. (canceled)

27. A method of wireless communication performed by a first network node, comprising:
communicating a reference signal using at least one antenna element disposed at one or more locations on a radio frequency reflection array associated with the first network node; and
communicating with a second network node based at least in part on a characteristic of the reference signal.

28-30. (canceled)
